(19) United States
(12) Patent Application Publication
(10) Pub. No.: US 2026/0336684 A1
(43) Pub. Date: Oct. 29, 2026

(54) METHODS AND APPARATUS FOR OPERATING AN ACTUATOR AND SYSTEM WITH ACTUATOR

(71) Applicant: Ford Global Technologies, LLC, Dearborn, MI (US)

(72) Inventors: Oliver Nehls, Düsseldorf (DE); Sergio Codonesu, Aachen (DE); Alexander Ein Waldt, Köln (DE); Gerhard Friederich, Bornheim (DE); Goetz-Philipp Wegner, Dortmund (DE)

(21) Appl. No.: 19/566,290

(22) Filed: Mar. 13, 2026

(30) Foreign Application Priority Data
Apr. 23, 2025 (DE) 102025115605.0

(51) Int. Cl. B62D 5/00; F16H 7/08

(52) U.S. Cl. CPC B62D 5/001; F16H 7/08; F16H 2007/0887

(57) ABSTRACT

Methods and apparatus for operating an actuator and to a system with at least one actuator are disclosed. A disclosed apparatus for operating an actuator with a belt drive includes interface circuitry communicatively coupled to first and second sensors, machine readable instructions, and at least one programmable circuitry to cause a specified torque to be applied to a motor shaft of the belt drive, determine a first rotation angle of the motor shaft based on first output of the first sensor, determine a second rotation angle of an output shaft of the belt drive based on second output of the second sensor, determine a reaction time of the output shaft based on the torque applied to the motor shaft, the first rotation angle and the second rotation angle, estimate a tension of a toothed belt that couples the output shaft to the motor shaft based on the determined reaction time, and adjust operation of the actuator based on the tension.

### RELATED APPLICATION

This patent claims priority from DE Patent Application Number 102025115605.0, which was filed on Apr. 23, 2025, and is hereby incorporated herein by reference in its entirety.

### FIELD OF THE DISCLOSURE

The disclosure relates to methods and apparatus for operating an actuator and to a system with at least one actuator.

### BACKGROUND

Steer-by-wire (SBW) steering systems are a further development of EPAS steering systems (“Electric Power Assisted Steering”). While EPAS steering systems rely on a mechanical coupling to transmit the driver's steering input directly to the steerable road wheels, SBW steering systems have no direct mechanical connection. Instead, SBW steering systems have two actuator subsystems to ensure the lateral guidance of the vehicle and feedback about the vehicle including a steering wheel actuator (hereinafter referred to as FBA for “feedback actuator”) and a road wheel actuator (RWA). The FBA generates a feedback torque. The driver's steering input is detected and transmitted to the RWA so that it can output a torque to adjust the orientation of the steerable road wheels depending on the steering input.

### SUMMARY

An example apparatus for operating an actuator with a belt drive includes interface circuitry communicatively coupled to first and second sensors, machine readable instructions, and at least one programmable circuitry to cause a specified torque to be applied to a motor shaft of the belt drive, determine a first rotation angle of the motor shaft based on first output of the first sensor, determine a second rotation angle of an output shaft of the belt drive based on second output of the second sensor, determine a reaction time of the output shaft based on the torque applied to the motor shaft, the first rotation angle and the second rotation angle, estimate a tension of a toothed belt that couples the output shaft to the motor shaft based on the determined reaction time, and adjust operation of the actuator based on the tension.

An example method includes causing a specified torque to be applied to a motor shaft of a belt drive of an actuator, determining a first rotation angle of the motor shaft based on first output of the first sensor, determining a second rotation angle of an output shaft of the belt drive based on second output of the second sensor, determining a reaction time of the output shaft based on the torque applied to the motor shaft, the first rotation angle and the second rotation angle, estimating a tension of a toothed belt that couples the output shaft to the motor shaft based on the determined reaction time, and adjusting operation of the actuator based on the estimated tension.

An example non-transitory machine readable storage medium includes instructions to cause programmable circuitry to at least cause a specified torque to be applied to a motor shaft of the belt drive, determine a first rotation angle of the motor shaft based on first output of the first sensor, determine a second rotation angle of an output shaft of the belt drive based on second output of the second sensor, determine a reaction time of the output shaft based on the torque applied to the motor shaft, the first rotation angle and the second rotation angle, estimate a tension of a toothed belt that couples the output shaft to the motor shaft based on the determined reaction time, and adjust operation of the actuator based on the tension.

### BRIEF DESCRIPTION OF THE DRAWINGS

Examples disclosed herein and further advantageous examples and developments of the same are explained and described in more detail below with reference to the examples illustrated in the drawings. In the figures:

FIG. 1 shows a schematic representation of a vehicle having a steering system according to examples disclosed herein.

FIG. 2 shows a schematic representation of a detail of a belt drive of the system according to examples disclosed herein.

FIG. 3 shows a further schematic representation of a belt drive of the system according to examples disclosed herein.

FIG. 4 shows a schematic representation of a method according to examples disclosed herein for operating an actuator with a belt drive.

FIG. 5 is a block diagram of an example processing platform including programmable circuitry structured to execute, instantiate, and/or perform the example machine-readable instructions and/or perform the example operations of FIG. 4 to implement electronic steering systems and/or components thereof disclosed herein.

### DETAILED DESCRIPTION

Steer-by-wire (SBW) steering systems implement actuator subsystems to ensure lateral guidance of a vehicle and feedback about the vehicle. The actuators include a steering wheel actuator (hereinafter referred to as FBA for “feedback actuator”) and a road wheel actuator (RWA). A fault in these or other actuators may result in them no longer being able to output torque from the electric motor of the respective actuator, meaning that the orientation of the steering wheel or the steerable road wheel can no longer be influenced.

Numerous types of transmissions, such as planetary, rack and pinion, and worm transmissions, can generally be used for the actuators. However, belt drives with a toothed belt are often used in such actuators, as they typically have low friction, low wear, and high operating efficiency. By contrast, V-belt drives, for example, are rarely used in steering systems because belt slip can only be reliably prevented with great effort due to the lack of teeth on the pulley.

To ensure the advantages of the belt drive, the belt tension must be adjusted and maintained within a specific parameter range. If the belt tension drops too much, the likelihood of the belt jumping increases. If the belt slips, the position between the two shafts of the belt drive changes unintentionally, so that the torque is not transmitted correctly.

The belt tension is usually measured indirectly during the installation of the belt drive. The measurement is performed, for example, by exciting the belt and recording the frequency profile resulting from the excitation. The belt tension can be estimated from the frequency profile. Another typical approach is based on applying a force to the belt and measuring the translation of the belt. A further approach consists of rotating the shaft in a controlled manner and measuring the torque required for rotation. The required torque corresponds to the friction of the belt drive, from which the belt tension can, in turn, be estimated. Contributions to the friction of the belt drive can also be made, for example, by the bearings of the arrangement (shafts) and the electric motor through its inertia. Since the other contributions to the friction of the belt drive are known or can be estimated in other ways, the friction of the belt drive itself and thus its belt tension can be estimated. These approaches are all based on the use of external measuring devices to record the various parameters, which means that they do not allow the belt tension to be estimated during normal operation and/or in the usual installation situation of the actuator.

If the belt of an FBA slips, the driver receives an incorrect feedback torque that does not correspond to the respective road wheel angle of a steerable road wheel, or they receive no feedback torque at all. As a result, it becomes difficult for the driver to set the desired steering angle. In general, the road wheel angle can be controlled based on the steering wheel angle or the motor angle of the FBA's electric motor, which correspond to each other. However, due to the slipping belt of the FBA, the motor angle no longer corresponds to the steering wheel angle, which can also lead to control errors depending on the design of the SBW steering system.

JP 2015-33951 A discloses a method for measuring belt tension for a steering device and a method for adjusting belt tension. The tension of a belt is examined based on a load when a probe is pressed against the surface of the belt and a constant amount of deflection is applied to the belt. In a state in which the probe is pressed against the surface of the belt, a steering wheel is moved through its entire range of rotation so that the belt is set in motion. A core-to-core distance of a drive pulley and a driven pulley is adjusted so that the maximum value and the minimum value of the measured load fall within a specified allowable range.

KR 2023-0151272 discloses an electric power steering system for a vehicle and a method for monitoring belt tension. The electric power steering system comprises a drive means comprising a motor controlled by an electronic control unit and a motor pulley coupled to the motor shaft. A strain gauge for measuring the tension of the belt is attached to the surface of the motor next to the motor shaft.

The problem to be solved can be seen as providing an actuator with a belt drive and a method for operating it, which make it possible to determine the belt tension for the actuator in the installation situation during operation of the actuator more precisely than before with less effort.

The problem is solved by examples disclosed herein. Advantageous examples are indicated in the following description, wherein each example, individually or in (sub)combination, can represent aspects of the disclosure.

According to examples disclosed herein, the object is also by a method for operating an actuator with a belt drive. The belt drive has a motor shaft that is at least indirectly coupled to a second shaft. The motor shaft and an output shaft of the belt drive are coupled to each other by a toothed belt. The method comprises the following steps:
A specifiable torque is applied to the motor shaft.
A first rotation angle of the motor shaft is detected by a first sensor.
A second rotation angle of the second shaft or the output shaft of the belt drive is detected by a second sensor.

### And:

A reaction time of the second shaft or the output shaft is determined by an evaluation device, depending on the torque applied to the motor shaft, the first rotation angle, and the second rotation angle.
The belt tension of the toothed belt is estimated by the evaluation device based on the determined reaction time and system parameters.

### Or:

The belt tension of the toothed belt is estimated by the evaluation device based on the applied torque, the first rotation angle, the second rotation angle, and additional system variables.

The example method above is based on the knowledge that the belt tension can be estimated during operation even without external measuring devices if the angles of rotation of the corresponding shafts of the belt drive or of shafts that are at least indirectly coupled to the belt drive are recorded during operation of the belt drive. Due to the elasticity of the belt, a change in speed of the motor shaft causes a corresponding change in speed of the second shaft or the output shaft only after a delay, which manifests itself as a reaction time. This elasticity depends, among other things, on the belt tension of the toothed belt. The timing characteristics of the timing belt in the belt drive are determined based on the reaction time or, alternatively, based on the rotation angle and corresponding system variables. This makes it possible to estimate the belt tension.

This enables a method by which the belt tension can be monitored at least intermittently or even continuously. As a result, manufacturing defects and/or signs of wear can be detected more precisely than before, reducing maintenance costs, for example, as maintenance intervals can be extended. In addition, unwanted operating scenarios, such as a tear in the timing belt, can be prevented more reliably than before. Furthermore, the method enables additional applications for the actuator. For example, some autonomous or semi-autonomous applications require intermittent or continuous monitoring of all components involved, which is made possible by the method with regard to the belt drive of the actuator. In addition, the estimated belt tension can be used for other functionalities. For example, the estimated belt tension can be used by a hand detection sensor that detects hand contact based on torque applied to a shaft.

The system parameters may relate to fundamental properties of the actuator, such as the mass moments of inertia of components actuated by the actuator, such as a steering column to which a steering wheel is mounted, or a pinion or recirculating ball gear coupled to a rack and indirectly to the steerable road wheels.

The additional system variables may include, for example, a torque gradient of the applied torque, a first rotation angle gradient of the first rotation angle, a second rotation angle gradient of the second rotation angle, a rotation angle velocity change of the motor shaft, a rotation angle velocity change of the second shaft, and a rotation angle velocity change of the output shaft. Which system variables are taken into account depends on the respective system design. This means that the method is highly variable.

Preferably, the second shaft is a shaft that is at least indirectly coupled to the output shaft of the belt drive. However, the mechanical coupling between the output shaft of the belt drive and the second shaft may comprise at least one additional component arranged in the force path between the output shaft of the belt drive and the second shaft. Nevertheless, the second shaft is coupled to the output shaft in such a way that actuation of the output shaft by a torque acting on the motor shaft of the belt drive immediately causes the second shaft to rotate. For example, the second shaft may be a shaft on which a pinion is mounted, or the second shaft may be a shaft of a recirculating ball gear that indirectly transmits the torque applied by the actuator to a component, such as the steerable road wheels.

Optionally, after a specified time interval after the torque is applied to the motor shaft, a counter-torque is applied to the motor shaft. The counter-torque is opposite to the torque. The counter-torque enables a more precise estimation of the belt tension, since, for example, elasticities and play of the belt drive in different directions of rotation can be taken into account. In addition, the belt drive and a component coupled to it, such as a steering wheel, can be brought to a standstill by the counter-torque. Furthermore, the component can also be returned to its starting position before movement.

The evaluation device preferably determines the additional system variables based on the applied torque, the first rotation angle, and the second rotation angle. For example, the evaluation device determines the torque gradient based on the applied torque, the first rotation angle gradient based on the first rotation angle, and the second rotation angle gradient based on the second rotation angle. For this purpose, the evaluation device may, for example, have a differentiating element. The detection and evaluation of the different gradients enables a detailed analysis of the dynamic states of the belt drive. This allows irregularities to be detected more efficiently.

According to one example, the evaluation device can take into account elasticities and frictions of the output shaft and components that are arranged in a force path between the output shaft and the second shaft or that have an influence on the force transfer between the output shaft and the second shaft, provided that the second rotation angle is detected with respect to the second shaft. The inclusion of these additional system parameters makes the model significantly more accurate, especially if the second rotation angle is not detected with respect to the output shaft of the belt drive, but with respect to another shaft indirectly coupled to it. For example, the rotation angle can be measured with respect to a pinion or a ball screw drive that is only indirectly coupled to the belt drive. This can be advantageous for reasons of installation space or because the rotation angle of the pinion or ball screw drive is recorded to estimate other system parameters. In this case, the elasticities and frictions of the output shaft, the pinion or the ball screw drive, and components arranged between the pinion or the ball screw drive and the output shaft can be taken into account. In addition, the elasticities and frictions of components that exert an influence on the force transfer can be taken into account, for example, a tensioning device for adjusting a belt tension of the toothed belt.

In one aspect, the torque may be a specified test torque or a torque specified during operation of the actuator. The flexibility offered by the possible use of test or operating torques allows the method to be seamlessly integrated into existing operating and control routines without the need for separate test cycles. In addition, the test torque can be used to ensure a specific load, which means that system parameters determined or estimated as part of the process, for example, can be reliably compared with parameters from repeated runs of the process.

The evaluation device also prefers to estimate the friction of the belt drive based on the applied torque, the first rotation angle, the second rotation angle, and the additional system variables. The additionally estimated friction values make it possible to characterize the system and all components involved more precisely. This leads to increased efficiency in estimating necessary maintenance measures and enables greater precision in additional functions that take friction values into account, such as a hand detection sensor.

Optionally, the evaluation device has an evaluation frequency that is lower than a specified frequency threshold value. For this purpose, the evaluation frequency can, for example, take into account relatively long integration times. As a result, high-frequency abrupt disturbances can be dampened so that their influence on the determined and estimated parameters is low. In addition, a defined lower evaluation frequency prevents the evaluation hardware from being overloaded, thereby increasing energy efficiency.

Preferably, the evaluation device may have a low-pass filter to ensure an evaluation frequency that is lower than the specified frequency threshold value.

In one aspect, the torque for a specified test interval may be variable and may exhibit an amplitude variation and/or frequency variation within the test interval. The variation in torque generates a broader database on the dynamic behavior of the belt drive. This allows different operating points to be recorded, which further increases the precision of the method. For example, frequency variations can be used to excite the natural frequencies of the system. Since the natural frequencies of the system depend on the elasticities of the system, the elasticities of the system can be estimated in this way.

In some examples, the specifiable torque is only applied at the beginning or end of a driving cycle. This is advantageous if the specifiable torque is a test torque, since other components coupled to the actuator are not yet or no longer used for normal operation at these points in time. In other words, this design enables the efficient use of system states that are already occurring, such as a start-up or shutdown process. This reduces the effect on ongoing operation, thereby increasing comfort and reducing the effort required for the process.

Optionally, the specifiable torque is only applied if the driver does not exert any torque on the steering wheel that is at least indirectly coupled to the actuator and/or if the driver is not present in the vehicle interior. This is advantageous if the specifiable torque is a test torque. This means that the vehicle steering is less affected. Driver comfort is thus high. In addition, consistent steering behavior is ensured, preventing any impairment of the driving experience. In other words, the process can then take place autonomously and unnoticed by the driver.

The evaluation device preferably outputs a notification if the estimated belt tension is less than a specified tension threshold value. For example, the notification can be output to a user interface.

Alternatively or additionally, in some examples, the evaluation device can cause a power limitation of the actuator and/or an external component coupled to the actuator if the estimated belt tension is less than a specified tension threshold value, for example, a limitation of the maximum output motor torque or a limitation of the maximum vehicle speed or the maximum requestable rotational speed or rotational speed change of the steerable road wheels, for example, based on a power limitation for the torque output by the RWA.

This allows the driver to be informed that the belt tension is too low so that they can adjust the use of the actuator and/or arrange for maintenance measures. The power limitation makes it possible to prevent improper operation of the system, so that the actuator can still be used for a certain period of time, albeit with reduced performance. Both measures result in increased operational reliability.

Optionally, the estimated belt tension must be less than the specified tension threshold value for a specified period of time for the notification to be output and/or the power limitation to take effect. This prevents isolated spring conditions from causing outliers that immediately trigger one of the aforementioned measures.

In some examples, different specified tension thresholds can be taken into account by the evaluation device for the power limitation and the notification. The fine-grained distinction between a notification and an active system intervention based on a power limitation enables a customized coordination of the behavior of the evaluation device with regard to different degrees of severity of tension divergence with respect to the at least one specified tension threshold value. This increases reliability and user acceptance.

According to a further aspect, examples disclosed herein also relate to a computer program product comprising commands which, when the computer program product is executed by a processor, cause said processor to carry out, at least in part, the previously described method, in particular the output and computing steps. The advantages achieved by the method described herein are also correspondingly achieved by the computer program product.

According to an additional aspect, examples disclosed herein also relate to a computer-readable storage medium comprising commands which, when the computer program product is executed by a processor, cause said processor to carry out, at least in part, the previously described method, in particular the output and computing steps. The advantages achieved by the method described herein are also achieved accordingly by the computer-readable storage medium.

According to a further aspect, the object is achieved according to examples disclosed herein by a system with at least one actuator. The actuator has a belt drive and an electric motor. The system comprises a first sensor, a second sensor, and an evaluation device. The evaluation device is coupled at least to the first sensor, the second sensor, and a control device of the actuator. The belt drive has a motor shaft that is at least indirectly coupled to a second shaft. The motor shaft and an output shaft of the belt drive are coupled to each other by a toothed belt. The electric motor is designed to apply a specifiable torque to the motor shaft of the belt drive depending on an adjustment signal from the control device. The first sensor is designed to detect a first rotation angle of the motor shaft. The second sensor is configured to detect a second rotation angle of the second shaft or the output shaft of the belt drive. The evaluation device is configured:
to determine a reaction time of the second shaft or the output shaft, depending on the torque applied to the motor shaft, the first rotation angle, and the second rotation angle, and
to estimate a belt tension of the toothed belt based on the determined reaction time and system parameters,
   and/or:
to estimate the belt tension of the timing belt based on the applied torque, the first rotation angle, the second rotation angle, and additional system variables.

The advantages achieved by the example method are also correspondingly achieved by the system. In particular, a system is created by which the belt tension of the timing belt can be estimated in the installation configuration and during operation without external measuring devices. This allows maintenance requirements to be optimized. Furthermore, the system enables increased accuracy and additional applications based on the estimated belt tension.

Optionally, the actuator is a road wheel actuator or a steering wheel actuator of a steering system for a vehicle. Use in a vehicle steering system allows continuous control and error-free operation of the steering. In addition, wear in the steering system and the corresponding maintenance costs are reduced.

Preferably, the measurement resolution and update rate of the sensors are high. Furthermore, the sensors can have low latency. This allows the angles of rotation to be recorded precisely, especially in terms of time.

In one aspect, the power limitation effected by the evaluation device may include limiting the maximum speed of the vehicle. For this purpose, the evaluation device can output a corresponding adjustment signal to an external component, for example, a driving control device. This ensures that the lateral forces acting on the vehicle are limited.

Optionally, the evaluation device is coupled to a user interface of the vehicle. The evaluation device can then output notifications to the driver of the vehicle.

In some examples, the second sensor is not arranged in such a way that it can detect the rotation angle of the output shaft, but it is preferably arranged with respect to the force path from the output shaft to the steering wheel or the steerable road wheel in such a way that it detects the rotation angle with respect to a component that is arranged as close as possible to the output shaft. As a result, only a few additional components are arranged in the force path between the component and the output shaft. As a result, the additional contributions of the other components arranged in the force path between the component and the output shaft are small, particularly with regard to the friction and elasticities caused by the additional components. This simplifies the estimation of the belt tension and makes it more precise, even though the second rotation angle is not measured in relation to the output shaft, but in relation to a component that is only indirectly coupled to it.

Preferably, the second sensor can also be designed as a linear rack sensor, as a pinion sensor integrated into a pinion disc that rotates around the second shaft, or as a transmission sensor that detects the movement of a component of the recirculating ball gear.

According to a further aspect, the object is also achieved by a vehicle with a steering system as described above. The advantages achieved by the steering system are also correspondingly achieved by the vehicle.

In the sense of the disclosure, vehicles can in particular encompass land vehicles (i.e., inter alia, off-road and road vehicles such as passenger cars, buses, trucks and other commercial vehicles). Motor vehicles may be manned or unmanned. The vehicles can have an internal combustion engine, or alternatively can have an electric motor for propulsion, or can be hybrid vehicles.

All the features mentioned below with respect to the examples and/or the accompanying figures can be combined individually or in any sub-combination with features of examples disclosed herein, including features of preferred examples.

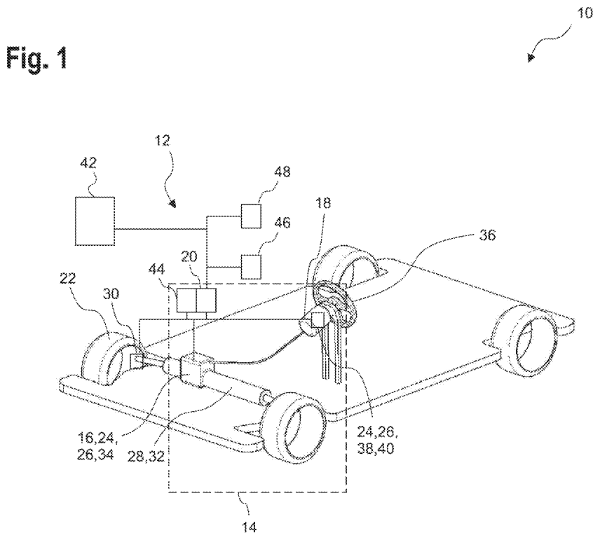

FIG. 1 shows a vehicle 10 having an example steering system 12. The steering system 12 is designed here, for example, as an SBW steering system. The steering system 12 comprises a system 14 in accordance with teachings of this disclosure.

The steering system 12 comprises an RWA 16. The steering system 12 also comprises an FBA 18 and a control device 20. The FBA 18 and the RWA 16 are coupled together.

According to this example, the steering system 12 has only a single control device 20. In general, however, the RWA 16 and the FBA 18 may each have separate control devices 20 that control the respective actuator.

According to this example, the RWA 16 is indirectly coupled to steerable road wheels 22 of the vehicle 10. For this purpose, the RWA 16 according to the present example comprises an electric motor 24 which is coupled to a belt drive 26. The belt drive 26 is at least indirectly coupled to a rack 28. The RWA 16 can output a torque by the electric motor 24, which acts on the rack 28 by the belt drive 26. This allows the position of the rack 28 to be varied along the rack path.

The rack 28 is at least indirectly coupled to the steerable road wheels 22 of the vehicle 10. The displacement of the rack 28 in relation to a reference position, such as a zero position (straight-ahead position), results in a change in the orientation of the steerable road wheels 22 around the wheel steering axes of the respective road wheels 22.

The steering system 12 has a road wheel angle sensor 30 designed to capture a road wheel angle of the steerable road wheels 22 about the respective wheel steering axis and to transmit same to the control device 20.

In an alternative example, instead of a road wheel angle sensor 30, the SBW steering system 12 may also have a rack sensor 32 which captures a position of the rack 28 relative to a reference position. Since the rack 28 is coupled to the steerable road wheels 22, a deflection of the rack 28 causes the steerable road wheels 22 to rotate about the respective wheel steering axes. For this reason, the orientation of the steerable road wheels 22 can be determined from the respective detected rack position, in particular by the control device 20 of the steering system 12.

In some examples, instead of a road wheel angle sensor 30, a pinion sensor 34 can also be used, which indicates the position and/or orientation of a pinion that is at least indirectly coupled to the RWA 16. The pinion is mounted on a shaft and rotates about its axis of rotation depending on the torque output by the RWA 16. Since the pinion is also indirectly coupled to the steerable road wheels 22, the orientation and/or position of the pinion can be used to determine the orientation of the steerable road wheels 22.

In a further alternative example, instead of the road wheel angle sensor 30, a sensor can also be used which detects the movement of a component of a ball screw drive. The ball screw drive is used to translate the rotary movement into a translatory movement. The only decisive factor is that the movement of a component is detected whose movement corresponds indirectly to the movement of the steerable road wheels, taking into account specific transmission ratios, for example.

Of course, multiple sensor units may also together form a sensor, which enables mutual plausibility checks and redundancy.

The steering system 12 also comprises a steering wheel 36, to which the FBA 18 is at least indirectly coupled, for example, via a steering column. The FBA 18 similarly has an electric motor 24. Using the electric motor 24, the FBA 18 can exert a torque that acts on the steering wheel 36 via a belt drive 26 of the FBA 18. The torque influences the steering wheel angle and/or the steering wheel speed, for example based on an adjustment signal from the control device 20.

The FBA 18 is designed, in particular, to exert a feedback torque on the steering wheel 36 so that the driver of the vehicle 10 is given a feel for the lateral guidance of the vehicle 10.

The driver of the vehicle 10 can use the steering wheel 36 to make steering specifications for the vehicle 10.

The steering system 12 also comprises at least one steering wheel sensor 38 configured so that it captures a steering wheel angle, that is to say a steering wheel position, of the steering wheel 36 in relation to a reference position, for example a central position (zero position). Consequently, the steering wheel sensor 38 can be used to capture steering specifications from the driver of the vehicle 10 based on the steering wheel 36. In this respect, a specific current steering wheel angle and steering wheel speed are defined by a steering specification.

According to this example, the vehicle 10 also has a HOOD sensor 40 which is indirectly coupled to the steering wheel 36 in accordance with teachings of this disclosure. The HOOD sensor 40 comprises a torque sensor that is coupled to the steering column on which the steering wheel 36 is mounted. In the event of hand contact (i.e., when the driver grasps the steering wheel 36), the driver exerts a torque on the steering column, which can be detected by the torque sensor. This allows the HOOD sensor 40 to determine, based on the driver's contact with the steering wheel 36, that the driver has taken control of the steering wheel 36. The HOOD sensor 40 then transmits the detected hand contact to the control device 20.

In some examples, the control device 20 can also itself be configured to determine a hand contact, for example, based on additional sensor signals, such as interior sensors or capacitance-based sensors, which are partially incorporated into the steering wheel 36, or by an estimation algorithm or a model-based software function.

Even if a hand contact is described here, a contact can obviously also be detected or determined based on another, preferably uncovered, part of the body.

A current steering specification at the steering wheel 36 generally corresponds to a specific current road wheel setpoint angle according to which the steerable road wheels 22 are to be aligned. Since the road wheels 22 are coupled at least indirectly to the rack 28, a steering specification is equivalent to a specific rack position of the rack 28, according to which the rack 28 is to be moved so that a desired orientation of the road wheels 22 is set. Alternatively, the steering specification corresponds to a specific position and/or orientation of a pinion coupled to the RWA 16.

By changing the steering wheel position, the driver dynamically changes the current steering specification, which in turn results in a dynamic change in the rack position. In addition, based on the orientation of the steerable road wheels 22 or based on the rack position of the rack 28, a feedback torque is determined which can be achieved by the FBA 18 on the steering wheel 36. Based on the feedback torque, the driver is to be given a feel for the lateral guidance of the vehicle 10.

According to this example, the steering wheel sensor 38 is integrated into the FBA 18. In other examples, however, the steering wheel sensor 38 can be separate from the FBA 18. The steering wheel sensor 38 is configured such that it transmits the detected steering wheel angle to the control device 20.

The control device 20 of the steering system 12 is also configured to output corresponding adjustment signals to the electric motor of the RWA 16 or to a converter coupled to it. To execute the corresponding control routines, the control device 20 can take into account additional parameters of the vehicle 10, for example the vehicle speed.

To control the orientation of the steerable road wheels 22, the control device 20 outputs an adjustment signal to the electric motor 24 of the RWA 16 or to a converter connected to it. Due to the adjustment signal, an output torque is provided by the electric motor 24 of the RWA 16 to align the steerable road wheels 22 accordingly. The output torque from the electric motor 24 of the RWA 16 can also be applied to the rack 28 rather than directly to a road wheel 22, so that an alignment of the steerable road wheels 22 is indirectly varied.

For the various functionalities relating to the FBA 18 and the RWA 16, to influence the road wheels 22 or apply a torque to the steering wheel 36, separate partial control devices may also be provided, each individually assigned to the FBA 18 or the RWA 16. By contrast, only a common single control device 20 of the steering system 12 is used here.

The road wheel angle sensor 30 captures a road wheel angle of the steerable road wheels 22 and transmits the captured road wheel angle to the control device 20. The control device 20 determines a corresponding feedback torque, which is output to the steering wheel 36, taking into account the steering ratio. In an alternative, instead of the road wheel angle, the rack position of the rack 28 can also be detected and taken into account by a corresponding rack sensor, or the pinion orientation of a pinion coupled to the RWA 16 can be detected and taken into account by a pinion sensor.

According to this example, the vehicle 10 comprises a driving control device 42. The driving control device 42 is configured to perform autonomous or partially autonomous driving functionalities. For example, the driving control device 42 can autonomously influence the lateral guidance of the vehicle 10 in this way. For this purpose, the driving control device 42 can, for example, make a specification for the steering wheel angle, the steering wheel movement or a corresponding parameter, which is subsequently set accordingly by the control device 20 and/or the FBA 18 of the steering system 12. The steering wheel angle that is then set is measured by the steering wheel sensor 38 and communicated to the control device 20, or is communicated directly from the driving control device 42 to the control device 20 and/or the RWA 16. The driving control device 42 further receives the measurement data from the various sensors (e.g., the road wheel angle sensor 30, the steering wheel sensor 38 and the HOOD sensor 40).

According to this example, the steering system 12 also comprises an evaluation device 44, which is part of the system 14. The evaluation device 44 is designed here as a common evaluation device 44 for the RWA 16 and the FBA 18. In general, however, each actuator, i.e., the RWA 16 and the FBA 18, can also be assigned a single evaluation device 44.

The evaluation device 44 is also coupled to the electric motors 24 of the RWA 16 and the FBA 18, so that the evaluation device 44 has knowledge of the torques output by the electric motors 24.

In general, the evaluation device 44 is also coupled to sensors that are set up to detect rotation angles of shafts, for example, a motor shaft of the respective belt drive 26, an output shaft of the respective belt drive 26, or a shaft that is at least indirectly coupled to the respective output shaft of the belt drive. For example, this may be a shaft in the force path of the RWA 16 to the steerable road wheel 22, for example a shaft on which the pinion is mounted, the angular position of which can also be detected to determine the orientation of the steerable road wheels 22.

The corresponding sensors for detecting the angles of rotation are also part of the system 14.

Only a single system 14 is shown here, comprising the RWA 16 and the FBA 18. In general, however, the steering system 12 may also comprise two separate systems 14, each comprising only a single actuator.

In this respect, a system 14 comprises at least one actuator, for example the RWA 16 or the FBA 18, with an electric motor 24 and a belt drive 26, corresponding sensors, and the evaluation device 44.

Furthermore, the evaluation device 44 of the system 14 according to this example is coupled to a low-pass filter 46. The low-pass filter 46 can be used to attenuate high-frequency interference.

In addition, the evaluation device 44 is coupled to a user interface 48 of the vehicle 10. The evaluation device 44 can use the user interface 48 to send notifications to the driver.

In addition, the evaluation device 44 is coupled to the control device 20. For example, the evaluation device 44 can output adjustment signals to the control device 20 and thus influence the functioning of the steering system 12 and the actuators.

In general, the evaluation device 44 can also be part of the control device 20.

The steering system 12 can obviously also have a plurality of similar and generally identically functioning components, for example a plurality of steering wheel sensors 38, which ensure redundancy.

The steering system 12 is illustrated here as a front axle steering system. The vehicle 10 and the steering system 12 can optionally also have further steerable road wheels 22, for example rear wheels which are coupled to an additional joint or separate RWA 16.

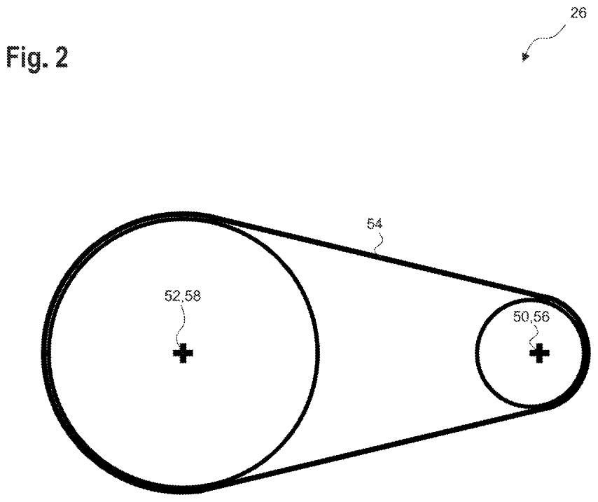

FIG. 2 shows a schematic illustration of a belt drive 26 of the system 14 according to examples disclosed herein.

The belt drive 26 comprises motor shaft 50 and an output shaft 52. The motor shaft 50 and the output shaft 52 are coupled to each other by a toothed belt 54, so that rotation of the motor shaft 50 causes rotation of the output shaft 52, at least if slippage of the toothed belt 54 is negligible.

The motor shaft 50 is coupled to the electric motor 24, which can output torque to rotate the motor shaft 50.

The radius difference between the motor shaft 50 and the output shaft 52 defines the transmission ratio of the belt drive 26.

The output shaft 52 is coupled to external components to be driven, for example, in the FBA 18, to a steering column on which the steering wheel 36 is mounted. In the RWA 16, for example, the output shaft 52 is coupled to a pinion or a recirculating ball gear, which can cause the rack 28 to translate and thus cause the steerable road wheels 22 to rotate about the wheel steering axes.

According to this example, a first sensor 56 of the system 14 is coupled to the motor shaft 50. The first sensor 56 is configured to capture at least a first rotation angle of the motor shaft 50 and to transmit same to the evaluation device 44.

According to this example, a second sensor 58 of the system 14 is coupled to the output shaft 52. The second sensor 58 is configured to capture a second rotation angle of the output shaft 52 and to transmit same to the evaluation device 44.

In general, the second sensor 58 may also be coupled to another shaft that is directly or indirectly coupled to the output shaft 52. The output shaft 52 is coupled force-transmittingly to the other shaft, the rotation angle of which is detected by the second sensor 58.

In some examples, an existing motor angle sensor of the actuator can be used as the first sensor 56 that detects the movement of the motor shaft. In the case of the RWA 16, the second sensor 58 can be a rack sensor 32 or a pinion sensor 34, depending on which sensor is already present. In the case of the FBA 18, the steering wheel sensor 38 or a steering column sensor can be used as the second sensor 58, depending on which sensor is already present. The steering column sensor is designed to detect rotation of the steering column. Since at least one of the aforementioned sensors is already present for the RWA 16 and the FBA 18 for controlling the steering system, the method and steering system 12 according to examples disclosed herein do not necessitate additional sensors to provide the described functionalities.

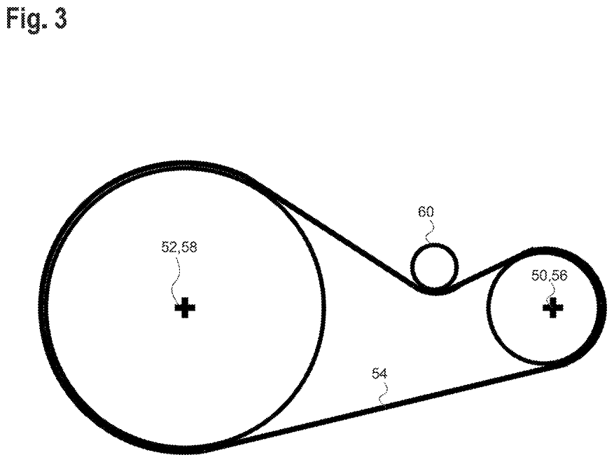

FIG. 3 shows a further schematic representation of a belt drive 26 of the system 14 according to examples disclosed herein. The belt drive 26 according to this example differs from the previous example in that it has an additional tensioning device 60 which is configured to vary the belt tension of the toothed belt 54. For this purpose, the tensioning device 60 can be moved, thereby influencing the length of the toothed belt 54 so that its belt tension varies. For example, the tensioning device 60 may be spring-mounted.

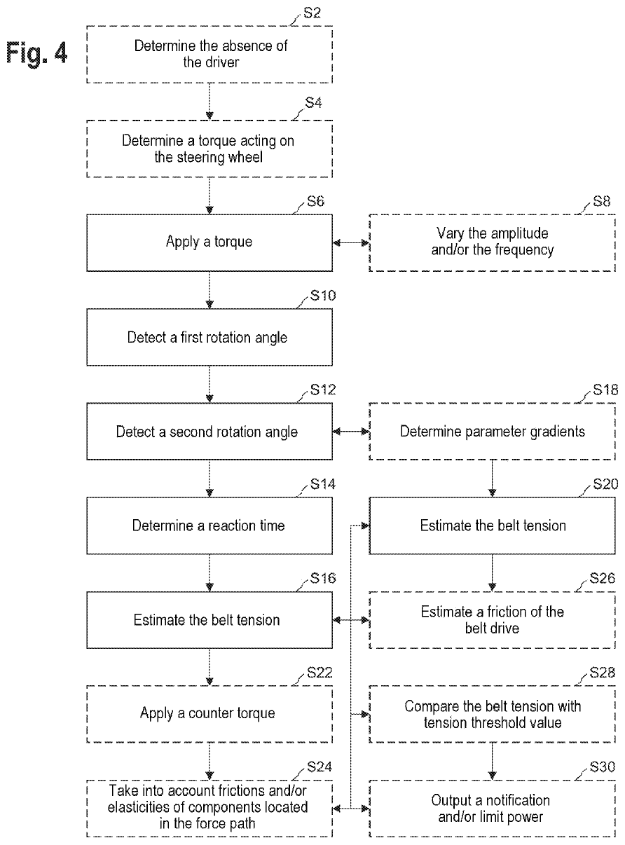

FIG. 4 shows a schematic representation of a method according to examples disclosed herein for operating an actuator with a belt drive 26. Optional example steps are illustrated by a dashed line.

In the optional example step S2, the evaluation device 44 determines whether a driver is present in the vehicle interior. For this purpose, the evaluation device 44 can, for example, be coupled to a component that indicates whether the vehicle 10 is locked and/or a door has been opened. In addition, interior sensors can also be used to determine whether a driver is present.

In the following optional example step S4, the evaluation device 44 determines whether a manual torque is applied to the steering wheel 36. The steering wheel sensor 38 can be used for this purpose. Alternatively or additionally, a torque sensor can also be used, which is set up to detect torque acting on the steering wheel 36 and/or the steering column. In addition, a HOOD sensor 40 can also be used to determine whether there is hand contact with the steering wheel 36.

In some examples, the following procedure depends on there being no driver in the interior and/or on the driver not exerting any torque on the steering wheel 36.

The method then comprises example step S6, in which a specifiable torque is applied to the motor shaft 50. The electric motor 24, which is coupled to the belt drive 26, can be used for this purpose.

The torque may be a test torque of which the characteristics are specified, for example, the amplitude, the duration, and/or the frequency with which the test torque is applied. For this purpose, the evaluation device 44 can, for example, output an adjustment signal to the control device 20, which then controls the electric motor 24 accordingly.

Alternatively, the specifiable torque can also be a torque applied during operation of the system 14, but without being applied by the driver. For example, the driving control device 42 can autonomously control the vehicle. By coupling the evaluation device 44 to the drive control device 42, the evaluation device 44 can then obtain information about the characteristics of the applied torque. Of course, the control device 20 can also control the operation of the actuators and transmit this information to the evaluation device 44 so that it is aware of the applied torques.

In some examples, the belt tension can also be determined when the driver exercises steering control and generates a counter-torque to the engine torque. In general, the precision of this approach is reduced. However, specific operating situations can be selected to ensure sufficient precision. For example, the approach can only be used if high engine torques and an approximately constant steering wheel speed are present, or if the steering wheel 36 is aligned according to a simulated end stop. Of course, the approach can also be transferred to the RWA 16 in a corresponding manner.

Optionally, example step S6 can be developed by the step S8. Accordingly, the torque applied to the motor shaft 50 is variable for a given test interval and exhibits an amplitude variation and/or frequency variation within the test interval. This allows, for example, the frequency-dependent properties of the belt drive 26 to be evaluated.

Following step S6, in example step S10, the first rotation angle of the motor shaft 50 is detected by the first sensor 56 and transmitted to the evaluation device 44.

In the subsequent step S12, the second rotation angle of the output shaft 52 (or another shaft coupled to the output shaft 52) is detected by the second sensor 58 and transmitted to the evaluation device 44.

The example method can then be continued in different ways, depending on whether it is being carried out in a test mode of the actuator in the installation configuration or during normal operation of the actuator.

In test mode, the evaluation device 44 determines in the following step S14 a reaction time of the second shaft or the output shaft 52, depending on the torque applied to the motor shaft 50, the first rotation angle, and the second rotation angle.

The evaluation device 44 then estimates the belt tension of the toothed belt 54 in example step S16 based on the determined reaction time and system parameters.

During normal operation of the actuator, the evaluation device 44 determines additional system variables in the optional example step S18 following step S12, for example, a torque gradient of the torque applied to the motor shaft 50, a first rotation angle gradient of the first rotation angle, and a second rotation angle gradient of the second rotation angle. For this purpose, the evaluation device 44 can use a differentiator.

The evaluation device 44 then estimates the belt tension of the toothed belt 54 in step S20. In doing so, the evaluation device 44 takes into account the torque applied to the motor shaft 50, the first rotation angle of the motor shaft 50, the second rotation angle of the output shaft 52 (or the other shaft), and additional system variables, in particular the torque gradient, the first rotation angle gradient, and the second rotation angle gradient.

This means that the belt tension of the toothed belt 54 can be estimated in different ways. The procedures are specifically adapted to the test operation or normal operation of the actuator.

The method can be continued from step S16 or step S20 with the optional steps S22, S24, S26, S28, and/or S30.

In the optional example step S22, the electric motor 24 applies a counter torque to the motor shaft 50, specifically after a specified period of time following the torque applied in step S6. This allows the actuator to be brought to a standstill or returned to its initial position, for example if the method is carried out in accordance with a specific test procedure.

The optional example step S24 provides that the evaluation device 44 takes into account in steps S16 or S20 frictions and/or elasticities of the output shaft 52 and of components arranged in the force path between the output shaft 52 and the shaft relative to which the second rotation angle is detected. Alternatively, frictions and/or elasticities that influence the force transfer between the output shaft 52 and the second shaft are taken into account. This allows the belt tension of the toothed belt 54 to be determined more precisely.

In accordance with the optional example step S26, the evaluation device 44 estimates the friction of the belt drive 26, which allows its properties to be evaluated more precisely. In doing so, the evaluation device 44 takes into account the torque applied to the motor shaft 50, the first rotation angle, the second rotation angle, and additional system variables, in particular the torque gradient, the first rotation angle gradient, and the second rotation angle gradient.

In the optional example step S28, the evaluation device 44 compares the estimated belt tension of the toothed belt 54 with at least one specified tension threshold value.

Based on the comparison from the optional step S28, the evaluation device 44 outputs a notification to the driver via the user interface 48 in the subsequent example optional step S30 if the estimated belt tension is less than the tension threshold value.

Additionally or alternatively, the evaluation device 44 can cause a power limitation if the estimated belt tension is less than the tension threshold value. To this end, the evaluation device 44 can, for example, output an adjustment signal to the control device 20 and/or the driving control device 42.

According to examples disclosed herein, different tension threshold values for the divergent measures can be taken into account in step S30.

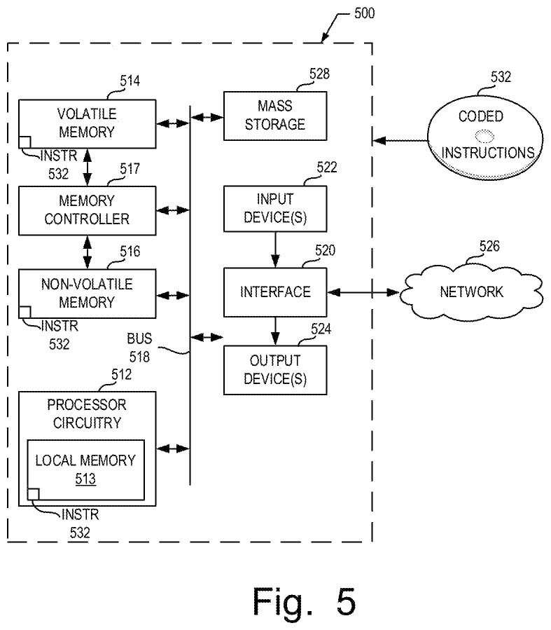

FIG. 5 is a block diagram of an example programmable circuitry platform 500 structured to execute and/or instantiate the example machine-readable instructions and/or the example operations of FIG. 4 to implement examples disclosed herein. The programmable circuitry platform 500 can be, for example, a control device, an electronic control unit (ECU), a self-learning machine (e.g., a neural network), or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 512 may be implemented by one or more semiconductor based (e.g., silicon based) devices.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a button, a touchscreen, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 532, which may be implemented by the machine-readable instructions of FIG. 4, may be stored in the mass storage device 528, in the volatile memory 514, in the non-volatile memory 516, and/or on at least one non-transitory computer readable storage medium such as a CD or DVD which may be removable.

Example methods, apparatus, systems, and articles of manufacture to monitor and adjust belt tension are disclosed herein. Further examples and combinations thereof include the following:

Example 1 includes an apparatus for operating an actuator with a belt drive, the apparatus comprising interface circuitry communicatively coupled to first and second sensors, machine readable instructions, and at least one programmable circuitry to cause a specified torque to be applied to a motor shaft of the belt drive, determine a first rotation angle of the motor shaft based on first output of the first sensor, determine a second rotation angle of an output shaft of the belt drive based on second output of the second sensor, determine a reaction time of the second shaft or the output shaft based on the torque applied to the motor shaft, the first rotation angle and the second rotation angle, estimate a tension of a toothed belt that couples the output shaft to the motor shaft based on the determined reaction time, and adjust operation of the actuator based on the tension.

Example 2 includes the apparatus as defined in example 1, wherein, after a specified time interval after the torque is applied to the motor shaft, one or more of the at least one programmable circuitry is to cause a counter-torque to be applied to the motor shaft, a direction of the counter-torque opposite to that of the torque.

Example 3 includes the apparatus of any one or more of examples 1-2, wherein the belt tension is estimated based on elasticities and frictions of the output shaft and components arranged in a force path between the output shaft and a second shaft provided that the second rotation angle is detected with respect to the second shaft.

Example 4 includes the apparatus of any one or more of examples 1-3, wherein the specified torque is a specified test torque or a torque specified during operation of the actuator.

Example 5 includes the apparatus of any one or more of examples 1-4, wherein one or more of the at least one programmable circuitry is to estimate a friction of a belt drive based on the applied torque, the first rotation angle, and the second rotation angle.

Example 6 includes the apparatus of any one or more of examples 1-5, wherein one or more of the at least one programmable circuitry has an evaluation frequency that is less than a specified frequency threshold value.

Example 7 includes the apparatus of any one or more of examples 1-6, wherein the specified torque is variable for a specified test interval and has an amplitude variation and/or a frequency variation within a test interval.

Example 8 includes the apparatus of any one or more of examples 1-7, wherein the specified torque is caused to be applied when a driver does not exert any torque on a steering wheel that is at least indirectly coupled to the actuator and/or if the driver is not present in a vehicle interior.

Example 9 includes the apparatus of any one or more of examples 1-8, wherein one or more of the at least one programmable circuitry is to cause a notification to be output and/or is to cause a power limitation of the actuator and/or an external component if the estimated belt tension is less than a tension threshold value.

Example 10 includes a method comprising causing a specified torque to be applied to a motor shaft of a belt drive of an actuator, determining a first rotation angle of the motor shaft based on first output of a first sensor, determining a second rotation angle of an output shaft of the belt drive based on second output of a second sensor, determining a reaction time of the output shaft based on the torque applied to the motor shaft, the first rotation angle and the second rotation angle, estimating a tension of a toothed belt that couples the output shaft to the motor shaft based on the determined reaction time, and adjusting operation of the actuator based on the estimated tension.

Example 11 includes the method as defined in example 10, including, after a specified time interval after the torque is applied to the motor shaft, applying a counter-torque to the motor shaft, a direction of the counter-torque opposite to that of the torque.

Example 12 includes the method of any one or more of examples 10-11, wherein the belt tension is estimated based on elasticities and frictions of the output shaft and components arranged in a force path between the output shaft and a second shaft provided that the second rotation angle is detected with respect to the second shaft.

Example 13 includes the method of any one or more of examples 10-12, wherein the specified torque is a specified test torque or a torque specified during operation of the actuator.

Example 14 includes the method of any one or more of examples 10-13, wherein the specified torque is applied in a variable manner for a specified test interval and has an amplitude variation and/or a frequency variation within a test interval.

Example 15 includes the method of any one or more of examples 10-14, wherein the specified torque is applied when a driver does not exert any torque on a steering wheel that is at least indirectly coupled to the actuator and/or if the driver is not present in a vehicle interior.

Example 16 includes a non-transitory machine readable storage medium comprising instructions to cause at least one programmable circuitry to at least cause a specified torque to be applied to a motor shaft of a belt drive of an actuator, determine a first rotation angle of the motor shaft based on first output of a first sensor, determine a second rotation angle of an output shaft of the belt drive based on second output of a second sensor, determine a reaction time of the output shaft based on the torque applied to the motor shaft, the first rotation angle and the second rotation angle, estimate a tension of a toothed belt that couples the output shaft to the motor shaft based on the determined reaction time, and adjust operation of the actuator based on the tension.

Example 17 includes the non-transitory machine readable storage medium as defined in example 16, wherein, after a specified time interval after the torque is applied to the motor shaft, one or more of the at least one programmable circuitry is to cause a counter-torque to be applied to the motor shaft, a direction of the counter-torque opposite to that of the torque.

Example 18 includes the apparatus of any one or more of examples 16-17, wherein the belt tension is estimated based on elasticities and frictions of the output shaft and components arranged in a force path between the output shaft and a second shaft provided that the second rotation angle is detected with respect to the second shaft.

Example 19 includes the apparatus of any one or more of examples 16-18, wherein the specified torque is caused to be applied when a driver does not exert any torque on a steering wheel that is at least indirectly coupled to the actuator and/or if the driver is not present in a vehicle interior.

Example 20 includes the apparatus of any one or more of examples 16-19, wherein one or more of the at least one programmable circuitry causes a notification to be output and/or causes a power limitation of the actuator and/or an external component if the estimated belt tension is less than a tension threshold value.

What is claimed is:

1. An apparatus for operating an actuator with a belt drive, the apparatus comprising:
interface circuitry communicatively coupled to first and second sensors;
machine readable instructions; and
at least one programmable circuitry to:
cause a specified torque to be applied to a motor shaft of the belt drive,
determine a first rotation angle of the motor shaft based on first output of the first sensor,
determine a second rotation angle of an output shaft of the belt drive based on second output of the second sensor,
determine a reaction time of the output shaft based on the torque applied to the motor shaft, the first rotation angle and the second rotation angle,
estimate a tension of a toothed belt that couples the output shaft to the motor shaft based on the determined reaction time, and
adjust operation of the actuator based on the tension.

2. The apparatus as defined in claim 1, wherein, after a specified time interval after the torque is applied to the motor shaft, one or more of the at least one programmable circuitry is to cause a counter-torque to be applied to the motor shaft, a direction of the counter-torque opposite to that of the torque.

3. The apparatus as defined in claim 1, wherein the belt tension is estimated based on elasticities and frictions of the output shaft and components arranged in a force path between the output shaft and a second shaft provided that the second rotation angle is detected with respect to the second shaft.

4. The apparatus as defined in claim 1, wherein the specified torque is a specified test torque or a torque specified during operation of the actuator.

5. The apparatus as defined in claim 1, wherein one or more of the at least one programmable circuitry is to estimate a friction of a belt drive based on the applied torque, the first rotation angle, and the second rotation angle.

6. The apparatus as defined in claim 1, wherein one or more of the at least one programmable circuitry has an evaluation frequency that is less than a specified frequency threshold value.

7. The apparatus as defined in claim 1, wherein the specified torque is variable for a specified test interval and has an amplitude variation and/or a frequency variation within a test interval.

8. The apparatus as defined in claim 1, wherein the specified torque is caused to be applied when a driver does not exert any torque on a steering wheel that is at least indirectly coupled to the actuator and/or if the driver is not present in a vehicle interior.

9. The apparatus as defined in claim 1, wherein one or more of the at least one programmable circuitry is to cause a notification to be output and/or is to cause a power limitation of the actuator and/or an external component if the estimated belt tension is less than a tension threshold value.

10. A method comprising:
causing a specified torque to be applied to a motor shaft of a belt drive of an actuator;
determining a first rotation angle of the motor shaft based on first output of a first sensor;
determining a second rotation angle of an output shaft of the belt drive based on second output of a second sensor;
determining a reaction time of the output shaft based on the torque applied to the motor shaft, the first rotation angle and the second rotation angle;
estimating a tension of a toothed belt that couples the output shaft to the motor shaft based on the determined reaction time; and
adjusting operation of the actuator based on the estimated tension.

11. The method as defined in claim 10, including, after a specified time interval after the torque is applied to the motor shaft, applying a counter-torque to the motor shaft, a direction of the counter-torque opposite to that of the torque.

12. The method as defined in claim 10, wherein the belt tension is estimated based on elasticities and frictions of the output shaft and components arranged in a force path between the output shaft and a second shaft provided that the second rotation angle is detected with respect to the second shaft.

13. The method as defined in claim 10, wherein the specified torque is a specified test torque or a torque specified during operation of the actuator.

14. The method as defined in claim 10, wherein the specified torque is applied in a variable manner for a specified test interval and has an amplitude variation and/or a frequency variation within a test interval.

15. The method as defined in claim 10, wherein the specified torque is applied when a driver does not exert any torque on a steering wheel that is at least indirectly coupled to the actuator and/or if the driver is not present in a vehicle interior.

16. A non-transitory machine readable storage medium comprising instructions to cause at least one programmable circuitry to at least:
cause a specified torque to be applied to a motor shaft of a belt drive of an actuator,
determine a first rotation angle of the motor shaft based on first output of a first sensor,
determine a second rotation angle of an output shaft of the belt drive based on second output of a second sensor,
determine a reaction time of the output shaft based on the torque applied to the motor shaft, the first rotation angle and the second rotation angle,
estimate a tension of a toothed belt that couples the output shaft to the motor shaft based on the determined reaction time; and
adjust operation of the actuator based on the tension.

17. The non-transitory machine readable storage medium as defined in claim 16, wherein, after a specified time interval after the torque is applied to the motor shaft, one or more of the at least one programmable circuitry is to cause a counter-torque to be applied to the motor shaft, a direction of the counter-torque opposite to that of the torque.

18. The non-transitory machine readable storage medium as defined in claim 16, wherein the belt tension is estimated based on elasticities and frictions of the output shaft and components arranged in a force path between the output shaft and a second shaft provided that the second rotation angle is detected with respect to the second shaft.

19. The non-transitory machine readable storage medium as defined in claim 16, wherein the specified torque is caused to be applied when a driver does not exert any torque on a steering wheel that is at least indirectly coupled to the actuator and/or if the driver is not present in a vehicle interior.

20. The non-transitory machine readable storage medium as defined in claim 16, wherein one or more of the at least one programmable circuitry causes a notification to be output and/or causes a power limitation of the actuator and/or an external component if the estimated belt tension is less than a tension threshold value.
